(19) United States
(12) Patent Application Publication
(10) Pub. No.: US 2025/0287858 A1
(43) Pub. Date: Sep. 18, 2025

(54) SYSTEMS AND METHODS FOR IMPROVED OPERATION OF A WORKING VEHICLE

(71) Applicant: Sabanto, Inc., Itasca, IL (US)

(72) Inventors: Craig Rupp, Ames, IA (US); Ravi Yenduri, Rolling Meadows, IL (US); Corwin Spaetti, Winthrop Harbor, IL (US); Adam Gaynor, Crystal Lake, IL (US); Aaron Petersdorf, Hampshire, IL (US)

(73) Assignee: Sabanto, Inc., Itasca, IL (US)

(21) Appl. No.: 19/225,110

(22) Filed: Jun. 2, 2025

Related U.S. Application Data
(62) Division of application No. 18/343,843, filed on Jun. 29, 2023.
(60) Provisional application No. 63/356,963, filed on Jun. 29, 2022.

(51) Int. Cl. A01B 69/04; A01B 76/00

(52) U.S. Cl. CPC A01B 69/008; A01B 76/00

(57) ABSTRACT

Various apparatus and procedures for improved operation of a working vehicle are provided. One embodiment provides for identifying areas where the vehicle must decrease speed in order to avoid damage to the vehicle or implement. Another embodiment provides for calculating the radius of an upcoming curve and adjusting vehicle speed as needed to avoid damage to the vehicle, implement, objects, or the work area. Another embodiment provides for adapting turning speed while maintaining acceptable path error. Another embodiment provides a method for directing a vehicle to an evacuation location. Another embodiment provides a method for switching vehicle and implement control from cloud-based control algorithms to in-vehicle control algorithms in the event of an evacuation.

### CROSS-REFERENCE TO RELATED APPLICATIONS

This application is a divisional of U.S. Ser. No. 18/343,843 filed Jun. 29, 2023, which claims priority to U.S. Provisional Patent Application No. 63/356,963 filed on Jun. 29, 2022, the entirety of both applications is hereby incorporated herein by reference.

### FIELD OF THE INVENTION

The disclosure relates generally to systems and methods of improving procedural operations of a working vehicle. In particular, in one embodiment, the disclosure provides for identifying areas where the vehicle must decrease speed in order to avoid damage to the vehicle or an implement towed by the vehicle. In another embodiment, the disclosure provides for calculating the radius of an upcoming curve that must be traveled by the vehicle and adjusting the speed of the vehicle as needed to avoid damage to the vehicle, a towed implement, objects in and around the work area, and the work area itself. In another embodiment, the disclosure provides for adapting turning speed while maintaining an acceptable path error. In another embodiment, the disclosure provides for multiple controls for enabling and disabling specific autonomous vehicle functions. In another embodiment, the disclosure provides for intercepting signals from vehicle controls, modifying the signals, and then passing the signals to a control unit of the vehicle. In another embodiment, the disclosure provides for vehicle-to-vehicle communications to provide information to a vehicle that has lost internet connectivity. In another embodiment, a method for improving safety of a work area where an autonomous or remotely controlled vehicle is operating is provided. In another embodiment, the disclosure provides for a method for targeted destruction of weeds in an agricultural field. In another embodiment, the disclosure provides for a method of detecting whether a PTO shaft is rotating. In another embodiment, the disclosure provides for prescriptive mowing of an area based on the time of year and type of birds that frequent the area. In another embodiment, the disclosure provides for a method for directing a vehicle to an evacuation location. In another embodiment, the disclosure provides for a method for switching vehicle and implement control from cloud-based control algorithms to in-vehicle control algorithms in the event of an evacuation. In another embodiment, the disclosure provides for a method for detecting buried obstacles in the vicinity of a working vehicle. In another embodiment, the disclosure provides for a method for generating a contoured path plan for performing a work operation in an area.

### BACKGROUND

Many procedural issues are encountered during operation of a working vehicle such as an agricultural vehicle or a mower whether those operations are performed using a manned vehicle or by an autonomous or remotely controlled vehicle.

In general, it is desirable to operate a work machine as fast as possible to achieve the greatest efficiency. This is particularly true when the vehicle is merely traversing an area and the implement is not actively working. However, some terrain features, soil types, or other features or conditions of an area being worked require that the work vehicle decrease speed to avoid becoming stuck or damaging the vehicle, a towed implement, objects in and around the work area, or the work area itself. In a typical arrangement, a driver operating the work vehicle would perceive a condition that requires a speed decrease and manually reduce vehicle speed; however, in an autonomous or remotely controlled vehicle there may not be a driver present to sense such difficulties. Therefore, a method for identifying areas where the vehicle must decrease speed is desired.

One feature of a work area that can potentially cause damage if traversed at too high of a speed is a sharp turn. In a typical arrangement, a driver operating the work vehicle would perceive an upcoming sharp curve that requires a speed decrease and manually reduce vehicle speed; however, in an autonomous or remotely controlled vehicle there may not be a driver present to sense such difficulties. Therefore, a method for determining the radius of an upcoming curve and modulating the speed of the vehicle to avoid damage is desired.

As a work vehicle operates in a work area, a number of turns need to be made. Turns need to be made at an appropriate speed. If turns are made too quickly, wheel slippage may occur, resulting in damage to crops, objects in and around the work area, or the work area itself. In a typical arrangement, a driver operating the work vehicle would perceive challenging soil conditions or would recognize increased load or slippage of the vehicle during a turn, and would manually reduce vehicle speed; however, in an autonomous or remotely controlled vehicle there may not be a driver present to sense such difficulties. In addition, dark conditions may make it more difficult for human operators or cameras to perceive difficulties caused by soil conditions. Additionally, soil conditions can change rapidly depending on weather events, and the quick changing nature of soil conditions makes predicting appropriate speed difficult, even in work areas that the vehicle has traversed before. Therefore, a method for adapting turn speed while maintaining an acceptable level of path error is desired.

Current autonomous vehicle systems are all or nothing; the vehicle is either in fully autonomous mode where the steering, throttle, and implement control are completely autonomously controlled by the system, or steering, throttle, and implement control are completely controlled manually by an operator. In reality, there are times when one or more aspects of autonomous control require operator intervention, but other aspects of autonomous control can be left to the system to automatically control, allowing the operator to concentrate on the aspects that require attention. Thus, a system that allows for independent switching between autonomous and manual modes for steering, throttle, and implement control is desired.

Tractors and other work vehicles typically have buttons, levers, dials, and other controls installed on an armrest or similar structure for controlling various aspects of the vehicle's operation. For example, speed, shifting, and implement control are manually controlled using such devices. Instructions from the armrest controls are communicated over a CAN bus to various components of the vehicle, such as an engine control unit (ECU), and the components respond to the communicated instructions. Autonomous vehicle control systems are available to generate instructions for controlling various components of the vehicle, but these systems are not customizable by an operator. Thus, a system for intercepting signals from vehicle controls, modifying the signals, and then passing the signals to a control unit of the vehicle is desired.

Autonomous vehicle systems rely on location information provided by a global navigation satellite system (GNSS) to indicate the precise location of the vehicle. GNSS may include a global positioning system (GPS), Galileo, or another navigation service. Navigation software running on a computer or microprocessor associated with the vehicle uses the real time location of the vehicle along with a mission plan to steer the vehicle and control speed and implement operation. A real time kinematic (RTK) system in communication with the vehicle may be used to provide offsets from a known location to enhance the accuracy of the location data provided by the GNSS. At times, a vehicle loses communications to the RTK service and backend, which leaves a vehicle unable to continue working until connectivity is restored. Thus, a system for vehicle-to-vehicle communications to provide information to a vehicle that has lost internet connectivity is desired.

Approaching an autonomous or remotely controlled vehicle can be dangerous for a field user who may incorrectly believe that a vehicle is paused. When a plurality of work vehicles, or swarm, is operating in a work area, remote users can become confused about which vehicle in the swarm they are controlling, and this can present safety issues for a field user who approaches a vehicle believing it is paused. Thus, a system and method for improving safety in the vicinity of an autonomous or remotely controlled vehicle is desired.

Once an agricultural field has been planted, removal of weeds is required to prevent unwanted vegetation from outcompeting the desired crop. One way of dealing with unwanted vegetation is to apply herbicides to the field after crops have emerged. Typically, a self-propelled sprayer, a sprayer implement, or aerial applicator traverses the field applying herbicide over the entire soil surface, resulting in excessive input costs and excessive chemicals that may runoff to waterways. Therefore, a method for targeted destruction of weeds in an agricultural field is desired.

In a mowing operation, an obstruction in the cutting mechanism can cause the clutch to slip on the gear box. When this occurs, a lot of heat is generated, and vegetation adjacent to the gear box can catch fire. Thus, a method for determining whether a PTO shaft has stopped rotating is desired.

In some areas, the presence of birds can cause problems for people and vehicles in the area. This is particularly true when the area is an airport as aircraft collisions with birds or birds entering the engines of aircraft can cause damage and even lead to crashes. Therefore, a method for discouraging birds from inhabiting an area is desired.

A controlled movement area (CMA) is an area where the presence or movement of people or vehicles is tightly controlled. Specified areas in airports and military bases are examples of CMAs. At times, a CMA must be evacuated, and people and vehicles are directed to leave the CMA. While movement within the CMA is controlled, the land in a CMA still needs to be maintained, such as by mowing grass and other vegetation. In a manned vehicle working in a CMA, the operator of the vehicle can make judgment calls about selecting a safe evacuation location and steering the vehicle quickly toward the evacuation location while avoiding injury or damage to the vehicle or to objects or people in the vehicle's path. When the work in a CMA is performed by autonomous or remotely controlled equipment, no human operator or remote observer may be present to make these judgment calls. Thus, a method of directing a vehicle to an evacuation location is desired. In the event of an evacuation order, vehicles and people must exit the CMA as quickly as possible. If path planning algorithms controlling the vehicle are running remotely, such as on a cloud-based remote server, delays in choosing and driving to an evacuation location could occur. Therefore, a method of switching vehicle and implement control from cloud-based control algorithms to in-vehicle control algorithms in the event of an evacuation is desired.

Some work areas contain buried equipment such as pipes or cables, portions of which can extend above the ground's surface. If struck by a mower blade or another working part of a vehicle or implement, damage can occur to the equipment and to the vehicle or implement. Thus, a method for detecting buried obstacles in the vicinity of a work vehicle is desired.

When operating on hilly terrain, a work vehicle such as a tractor and any implement being towed by the vehicle may experience wheel slippage where the wheels of the vehicle and/or the implement lose traction and spin, causing damage to the grass and other vegetation in the work area. Slippage is a particular problem when operating in straight lines on hilly terrain. Thus, a method for generating a contoured path plan for performing a work operation in an area is desired.

### BRIEF SUMMARY

In accordance with various embodiments of the invention, methods for improved operation of a working vehicle are provided. In one embodiment, a method for identifying areas where the vehicle must decrease speed is provided.

In another embodiment, a method for determining the radius of an upcoming curve and modulating the vehicle's speed based on the determined radius is provided.

In another embodiment, a method for adapting turn speed while maintaining an acceptable level of path error is provided.

In another embodiment, a system for independent switching between autonomous and manual modes for steering, throttle, and implement control is provided.

In another embodiment, a method for intercepting CAN messages and inserting custom instructions is provided.

In another embodiment, a system for providing vehicle-to-vehicle communications is provided.

In another embodiment, a system and method for improving safety in the vicinity of an autonomous or remotely controlled vehicle field is provided.

In another embodiment, a method for targeted destruction of unwanted vegetation in an agricultural field is provided.

In another embodiment, a method for determining whether the PTO shaft has stopped rotating is provided.

In another embodiment, a method for prescriptive mowing of an area based on the time of year and type of birds that frequent the area is provided.

In another embodiment, a method for directing a vehicle to an evacuation location is provided.

In another embodiment, a method for switching vehicle and implement control from cloud-based control algorithms to in-vehicle control algorithms in the event of an evacuation is provided.

In another embodiment, a method for detecting buried obstacles in the vicinity of a working vehicle is provided.

In another embodiment, a method for generating a contoured path plan for performing a work operation in an area is provided.

### BRIEF DESCRIPTION OF THE DRAWINGS

Having thus described the invention in general terms, reference will now be made to the accompanying drawings, which are not necessarily drawn to scale, and wherein:

FIG. 1 illustrates a typical tractor and implement arrangement.

FIG. 2 illustrates a method for identifying areas where the vehicle must decrease speed in accordance with an embodiment of the invention.

FIG. 3 illustrates a method for determining the radius of an upcoming curve in accordance with an embodiment of the invention.

FIG. 4 illustrates a method for adapting turn speed while maintaining an acceptable level of path error in accordance with an embodiment of the invention.

FIG. 5 illustrates an armrest system for a tractor which may be used for independent switching between autonomous and manual modes for steering, throttle, and implement control in accordance with an embodiment of the invention.

FIG. 6 illustrates a system for intercepting CAN messages and inserting custom instructions in accordance with an embodiment of the invention.

FIG. 7 illustrates a system for providing vehicle-to-vehicle communications in accordance with an embodiment of the invention.

FIG. 8 illustrates a system for improving safety in the vicinity of an autonomous or remotely controlled vehicle in accordance with an embodiment of the invention.

FIG. 9 illustrates a method for improving safety in the vicinity of an autonomous or remotely controlled vehicle in accordance with an embodiment of the invention.

FIG. 10 illustrates a method for targeted destruction of unwanted vegetation in an agricultural field in accordance with an embodiment of the invention.

FIG. 11 illustrates a system for determining if a PTO shaft has stopped rotating in accordance with an embodiment of the invention.

FIG. 12 illustrates a method for determining if a PTO shaft is rotating in accordance with an embodiment of the invention.

FIG. 13 illustrates a method for prescriptive mowing of an area based on the time of year and type of birds that frequent the area in accordance with an embodiment of the invention.

FIG. 14 illustrates a method for directing a vehicle to an evacuation location in accordance with an embodiment of the invention.

FIG. 15 illustrates a method for switching vehicle and implement control from cloud-based control algorithms to in-vehicle control algorithms in the event of an evacuation in accordance with an embodiment of the invention.

FIG. 16 illustrates a method for detecting buried obstacles in the vicinity of a working vehicle in accordance with an embodiment of the invention.

FIG. 17 illustrates a method for generating a contoured path plan for performing a work operation in an area in accordance with an embodiment of the invention.

### DETAILED DESCRIPTION

Some embodiments of the present invention will now be described more fully hereinafter with reference to the accompanying drawings, in which some, but not all, embodiments of the invention are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Some components of the apparatus or method steps are not shown in one or more of the figures for clarity and to facilitate explanation of embodiments of the present invention.

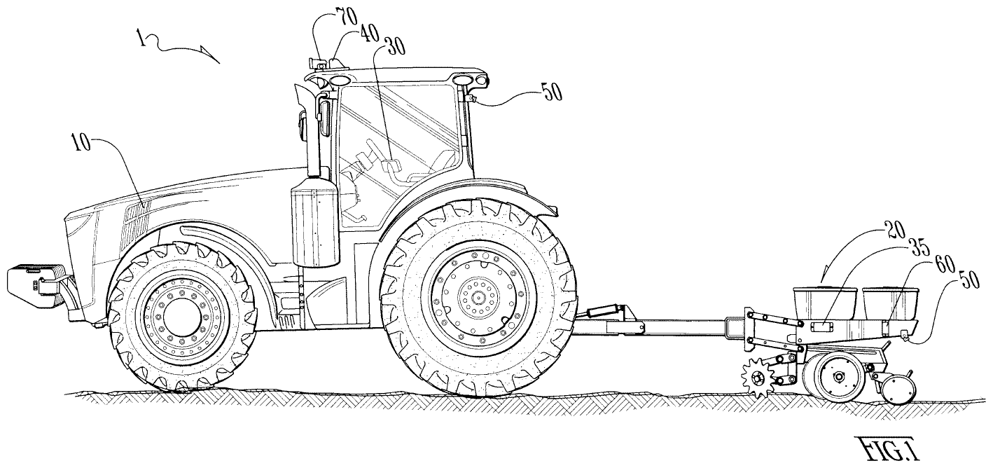

In accordance with one embodiment, FIG. 1 illustrates a typical arrangement 1 of a vehicle 10 and an implement 20. Vehicle 10 may be a manned or autonomous tractor capable of towing and powering implements. Alternatively, vehicle 10 may be a manned, autonomous, or remotely controlled harvester, sprayer, or mower. An implement 20 may be coupled to vehicle 10 using either a drawbar or three-point hitch. Implement 20 may include tillage equipment, a planter, a mower, or other implement. Vehicle 10 is equipped with one or more GNSS units 40 and one or more computers 30 and/or microprocessors 35. An implement 20 pulled by vehicle 10 may also be equipped with one or more GNSS units 40. GNSS unit 40 may be referred to as GNSS unit 40 or GNSS receiver 40 without departing from the scope of the disclosure. In addition, any references to readings of location data from GNSS unit 40 may refer to data from a GNSS unit 40 on vehicle 10, on implement 20, or any combination of readings from a vehicle 10 or implement 20 mounted GNSS unit 40.

A computer 30 mounted on or otherwise connected to vehicle 10 communicates with various systems of vehicle 10 and implement 20. For example, computer 30 is configured to receive and transmit signals to the CAN bus 620, engine control unit (ECU), and other systems of vehicle 10. Computer 30 also communicates with one or more GNSS units 40 mounted to vehicle 10 or implement 20. Computer 30 may be a tablet, smart phone, laptop, desktop computer, commercially available display for use in agricultural vehicles, terminal, or similar computing device. Computer 30 may be installed on the vehicle 10 or may be in a remote location. GNSS unit 40 is configured to receive satellite signals indicating the precise location of the GNSS unit 40 and vehicle 10 or implement 20. Software running on computer 30 is configured to control many aspects of the arrangement 1. For example, using location information from the GNSS unit 40, software running on computer 30 can control the movement of vehicle 10, raising and lowering of the implement 20, and controlling seed rates applied by the implement 20 when implement 20 is a planter. Software running on computer 30 is also configured to record data regarding the operation of the vehicle 10 and implement 20, including the path driven by vehicle 10, seed rates applied by the implement 20 when implement 20 is a planter throughout each planted field, and data generated by various sensors 60 mounted to the vehicle 10 or implement 20.

A microprocessor 35 mounted on implement 20 is electronically connected to any sensors mounted on the implement 20. Microprocessor 35 is configured to receive signals from any attached sensors 60 and perform processing to determine if sensor 60 readings are within acceptable ranges. Microprocessor 35 is also configured to receive and transmit signals to the computer 30. If microprocessor 35 detects an abnormal sensor reading, then that information is transmitted to computer 30, and the vehicle 10 or implement 20 can be stopped or other remediation measures can be taken. Throughout this disclosure, any processing of sensor 60 signals may be performed on either computer 30 or microprocessor 35. In a typical implement 20, simple processing tasks may be performed by microprocessor 35, and readings and results captured by microprocessor 35 are communicated to computer 30 for further processor or other action.

One or more cameras 50 may be installed on vehicle 1 or implement 20. Camera 50 connects to computer 30 or microprocessor 35 by a wired or wireless connection, and camera 50 is configured to capture images of vehicle 1, implement 20, or the surrounding area and send the images to computer 30 or microprocessor 35.

One or more sensors 60 may be installed on vehicle 1 or implement 20. Sensor 60 connects to computer 30 or microprocessor 35 by a wired or wireless connection, and sensor 60 is configured to capture readings of various parameters affecting vehicle 10, implement 20, or the surrounding area and send the readings to computer 30 or microprocessor 35.

Vehicle 10 may additionally be equipped with an obstacle detection system 70 configured to detect people or objects in the path of or near vehicle 10. Obstacle detection system 70 may comprise any combination of sensors and software running on computer 30 or microprocessor 35 configured to detect people or objects in the path of or near vehicle 10 or implement 20.

### Identifying Slow Zones

When a vehicle 10 is performing a work operation, the vehicle 10 must slow down when traversing certain terrain features, soil types, or other conditions or features that would otherwise cause damage to the vehicle 10 or an implement 20 being towed by vehicle 10. Such features or conditions require the vehicle 10 to reduce its speed and are referred to in the disclosure as “slow zones.” Waterways, sharp curves, and steep hills located in the work area are examples of areas that should be treated as slow zones; however, there are many other features or conditions in a work area that should be treated as slow zones.

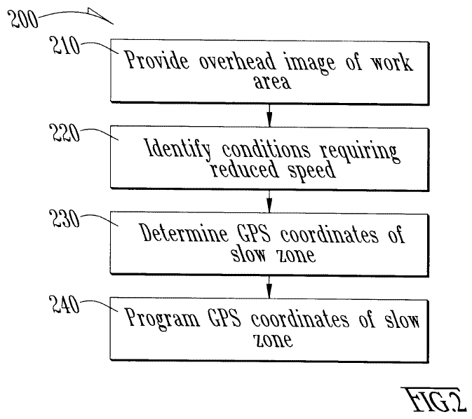

As shown in FIG. 2, a method 200 for identifying slow zones in a work area begins at step 210 with providing a representation of the area to be worked by a vehicle 10 equipped with a GNSS unit 40 and a computer 30 and/or a microprocessor 35. Vehicle 10 may be a tractor pulling an implement 20, a harvester, a self-propelled sprayer, a mower, or other vehicle used for performing work operations on an area of land. Vehicle 10 may be a manned or unmanned vehicle. The representation of the area to be worked may comprise a map of the work area, satellite images of the work area, images captured by a drone flown over the work area, or another view or data set that provides a bird's eye view of the work area.

At step 220, conditions that require vehicle 10 to reduce speed are identified, either manually by a person viewing the overhead image provided in step 210 or by image processing software analyzing the image provided in step 210.

At step 230, the GNSS coordinates of each slow zone are determined. The determination made at step 230 may be performed by determining the GNSS coordinates of the boundaries of each slow zone.

At step 240, the GNSS coordinates determined in step 230 are programmed in a format readable by path planning software running on computer 30 or microprocessor 35. The programmed coordinates may then be transmitted or physically transferred on a flash card or other media to computer 30 and/or microprocessor 35.

When operating outside of the slow zone, vehicle 10 will travel at a speed typical for the operation. The speed and path of vehicle 10 may be controlled according to a mission plan loaded in computer 30, and operation of any implement 20 may be controlled by software running on computer 30 or microprocessor 35. When readings captured by GNSS unit 40 indicate that the vehicle 10 is approaching or within the slow zone, the speed of vehicle 10 is reduced to avoid damage to vehicle 10 and/or implement 20. In some embodiments, the speed of the vehicle 10 is reduced prior to reaching the slow zone to ensure the vehicle 10 is travelling at an appropriate speed at all times. When readings captured by GNSS unit 40 indicate that the vehicle 10 has exited the slow zone, the speed of vehicle 10 may increase to normal speed for the operation being performed by the vehicle 10 and implement 20.

### Varying Vehicle Speed Based on Upcoming Radius

In general, it is desirable to operate a work vehicle 10 at as high of a ground speed as possible to complete a work operation efficiently. This is particularly true when the vehicle is merely traversing an area and the implement is not actively working. However, damage can result to the vehicle 10, implement 20, objects in and around the work area, and the work area itself if a sharp curve is traveled at too high of a ground speed.

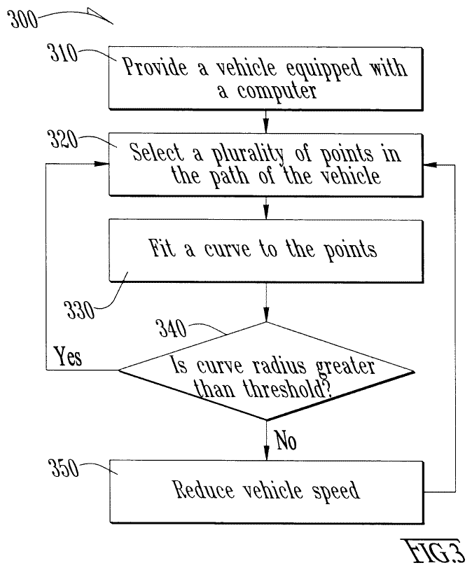

As shown in FIG. 3, a method 300 for determining the radius of an upcoming curve begins at step 310 with providing a vehicle 10 equipped with a computer 30 and/or a microprocessor 35. Vehicle 10 may additionally be equipped with a forward-facing camera 50. Vehicle 10 may be a tractor pulling an implement 20, a harvester, a self-propelled sprayer, a mower, or other vehicle used for performing work operations on an area of land. Vehicle 10 may be a manned or unmanned vehicle. The speed and path of vehicle 10 may be controlled according to a mission plan loaded in computer 30, and operation of any implement 20 may be controlled by software running on computer 30 or microprocessor 35.

At step 320, a plurality of points in the imminent path of vehicle 10 are identified as the vehicle 10 traverses the work area. In one embodiment, 50 equally spaced points in the immediate path of vehicle 10 are identified; however, any number of points or distance before vehicle 10 may be used without departing from the scope of the disclosure. The selected points may be selected from imagery captured by the camera 50, or the selected points may be selected from a predetermined path programmed into software running on computer 30 or microprocessor 35.

At step 330, software running on computer 30 or microprocessor 35 fits a curve to the points selected at step 320. Software running on computer 30 or microprocessor 35 calculates the radius of the curve that was fit. If the points from step 320 lie in a generally straight line, then the curve fit at step 330 will have a large radius. If the points from step 320 lie in a curve, then a smaller radius indicates a sharper curve. Step 330 may be performed in real time as the vehicle 10 operates in the work area, or step 330 may be performed in advance when the path plan is created.

At step 340, the radius of the curve fit at step 330 is compared to a threshold. If the radius of the curve is above a defined threshold, then the vehicle 10 continues normal operation without reducing ground speed and method 300 returns to step 320. If the radius of the curve is less than the defined threshold, then the method 300 proceeds to step 350.

At step 350, the ground speed of vehicle 10 is reduced to a safe level based on the radius of the curve calculated at step 330. The adjusted vehicle 10 speed may be calculated based on a function that calculates a safe ground speed based on the radius calculated at step 330. Alternatively, a safe ground speed may be selected from a predefined list of safe speeds based on the radius calculated at step 330.

Steps 320-350 are repeated continuously as needed as long as the vehicle 10 is operating.

### Adaptive Turn Speed

Typical agricultural operations involve operating a vehicle 10 over a series of passes in a field. At the end of each pass, vehicle 10 must turn in order to start the next pass to be worked. The ground speed of vehicle 10 must be reduced to an appropriate level to successfully navigate through the expected turn path. Soil conditions can vary widely from day to day in a given location, making it difficult to define appropriate turn speeds in advance of a work operation. Implement weight, ground slope, and machine dynamics can also affect the accuracy with which vehicle 10 navigates a turn. Often, a lower speed than necessary is chosen to compensate for uncertain soil conditions. A method 400 is provided that lowers the speed of vehicle 10 to a very low speed that is unlikely to result in wheel slippage, and the speed of vehicle 10 may be increased during the turn if an acceptable level of path error is maintained.

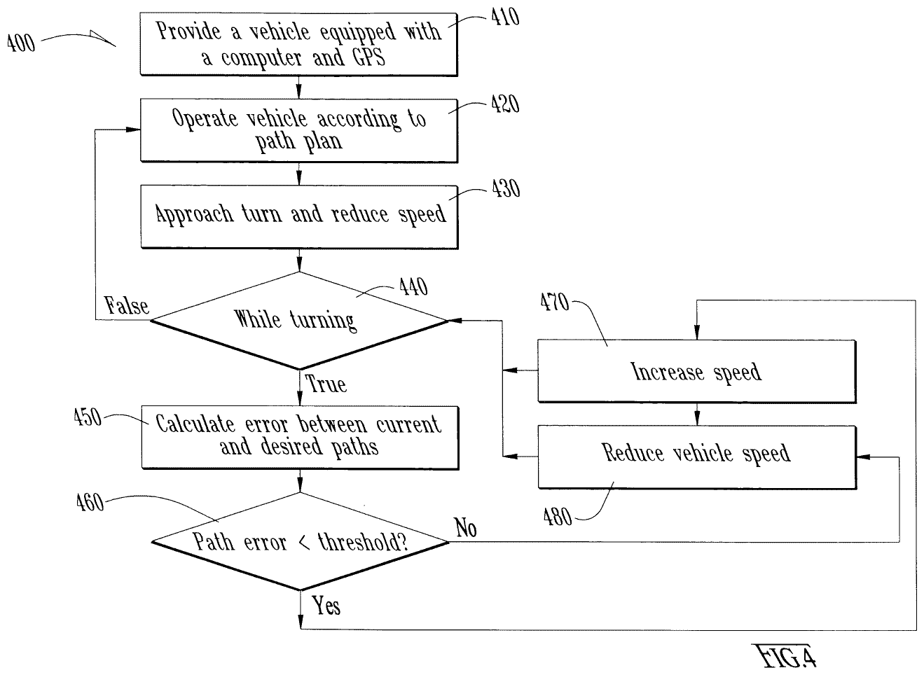

As shown in FIG. 4, a method 400 for adapting the turn speed of vehicle 10 while maintaining an acceptable level of path error begins at step 410 with providing a vehicle 10 equipped with a computer 30 and/or a microprocessor 35 and a GNSS unit 40. Vehicle 10 may be a tractor pulling an implement 20, a harvester, a self-propelled sprayer, a mower, or other vehicle used for performing work operations on an area of land. Vehicle 10 may be a manned or unmanned vehicle.

The speed and path of vehicle 10 may be controlled according to a path plan or mission plan loaded in computer 30, and operation of any implement 20 may be controlled by navigation software running on computer 30 or microprocessor 35. At step 420, vehicle 10 is operated according to the path plan. The navigation software takes regular readings from the GNSS unit 40 and adjusts the path of the vehicle 10 as needed to keep vehicle 10 on the desired path.

At step 430, navigation software determines from readings taken by GNSS 40 that vehicle 10 is approaching a turn and reduces the speed of vehicle 10 to a low initial speed in advance of the turn. The low initial speed is a speed that is unlikely to result in wheel slippage under poor conditions. In one embodiment, the initial speed for the current turn may be set to the speed determined by method 400 during the previous turn or during the turn performed at the closest location to the current turn.

At step 440, the navigation software determines if vehicle 10 is in a turn based on the current location indicated by readings from the GNSS unit 40 and from the path plan. If vehicle 10 is navigating through a turn, the method 400 proceeds to step 450. If vehicle 10 is not navigating through a turn, the method 400 returns to step 420, and vehicle 10 resumes normal following of the path plan.

At step 450, readings from the GNSS unit 40 are captured to determine the current location of the vehicle 10 as the vehicle 10 navigates through a turn, and the navigation software running on computer 30 or microprocessor 35 calculates the error between the location determined at step 450 and the desired path of vehicle 10. In one embodiment, the instantaneous location of vehicle 10 will be used to determine path error. Alternatively, the GNSS coordinates of a number of points recently travelled by vehicle 10 may be read from GNSS unit 40 and a curve fit to the points. For example, ten equally spaced points representing the last 10 feet traversed by the vehicle 10 may be captured and a curve fit to the points

At step 460, the error calculated at step 450 is compared to a threshold. If the calculated path error is below a defined error threshold, then a lack of wheel slippage is indicated, and the speed of vehicle 10 may be increased if the current speed is below a defined maximum turn speed. If the calculated error exceeds the defined error threshold, then the vehicle is too far from the desired path, and the method 400 proceeds to step 480.

At step 480, the ground speed of vehicle 10 is reduced. The adjusted vehicle 10 speed may be calculated based on a function that calculates a proper ground speed based on the error calculated at step 450. Alternatively, an appropriate speed may be selected from a predefined list of speeds based on the error calculated at step 450. Alternatively, an appropriate speed may be assigned to the vehicle according to the equation speed=desired_speed−alpha*error, where alpha is a gain parameter.

Steps 440-480 are repeated continuously as needed as long as the vehicle 10 is navigating through a turn. After the turn is completed, method 400 returns to step 420, and normal following of the path plan resumes. While method 400 is particularly useful for adapting turn speed, method 400 may be used at any point during the operation of vehicle 10 to select an appropriate ground speed for vehicle 10. The method 400 could be used at any point on a pass, modulating the speed of the vehicle 10 to keep the error in check.

### Selective Enabling and Disabling of Autonomous Functions

In an autonomous vehicle system, a vehicle 10 equipped with a GNSS unit 40 and computer 30 are provided. An implement 20 equipped with a microprocessor 35 may be attached to and pulled by vehicle 10. Autonomous navigation software running on computer 30 or microprocessor 35 control aspects of the autonomous operation of vehicle 10 and implement 20. Aspects of autonomous operation include steering control, throttle and transmission control, and implement 20 control. The autonomous navigation software uses data captured by the GNSS unit 40 to determine the location of vehicle 10 and/or implement 20, and the software generates commands communicated across the CAN bus 620 of the vehicle 10 and/or implement 20 to control various aspects of the work operation.

In prior art autonomous vehicle systems, all aspects of autonomous control of vehicle 10 and implement 20 are controlled by the autonomous navigation software; however, one or more aspects of autonomous control of a vehicle 10 occasionally require operator intervention, but other aspects of autonomous control can be left to the system to automatically control, allowing the operator to concentrate on the aspects that require attention. The operator of vehicle 10 may need to put the steering, throttle and transmission, or implement control, or some combination of the three into manual mode while allowing the autonomous system to control the other aspects of vehicle 10 operation. For example, if vehicle 10 is near a gully, the operator may want to control the implement manually and allow the vehicle 10 to steer and control speed autonomously. As another example, an obstacle in the work area may lead an operator to control steering or another aspect of the operation of vehicle 10 manually.

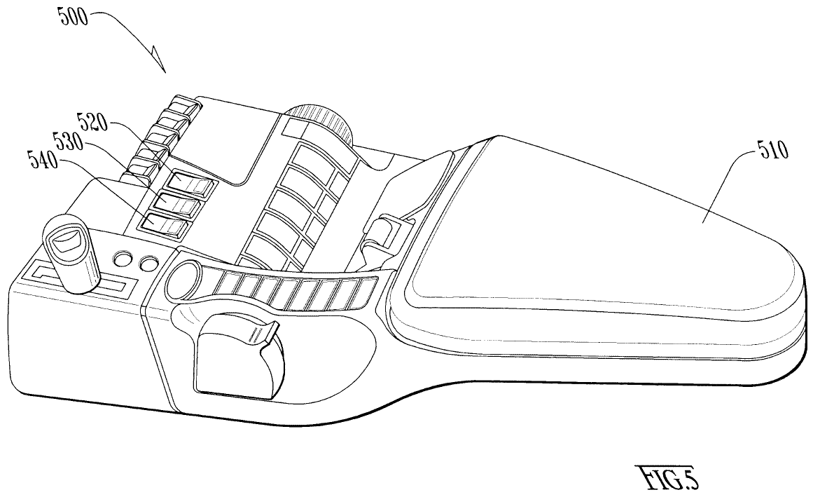

As shown in FIG. 5, a system 500 that allows for independent switching between autonomous and manual modes for steering, throttle and transmission, and implement 20 control is provided. Many work vehicles 10 include an armrest 510 having switches, dials, and other controls for controlling various aspects of the operation of the vehicle 10.

An autonomous/manual steering control 520 allows an operator to enable or disable autonomous steering of vehicle 10 while allowing autonomous speed and implement 20 control to continue to be performed by autonomous control software running on computer 30 or microprocessor 35. When autonomous/manual steering control 520 is actuated during autonomous operation of vehicle 10, the autonomous navigation software discontinues communicating steering commands across the CAN bus 620 of vehicle 10, and an operator may manually control steering of vehicle 10. When autonomous/manual steering control 520 is actuated during manual operation, the autonomous navigation software enables autonomous control of the steering of vehicle 10. While autonomous/manual steering control 520 is shown as a button on armrest 510, autonomous/manual steering control 520 may take the form of a switch, a selectable option on a touchscreen, or any other type of switch or control.

An autonomous/manual speed control 530 allows an operator to enable or disable autonomous control of the throttle and transmission of vehicle 10 while allowing autonomous steering and implement 20 control to continue to be performed by autonomous control software running on computer 30 or microprocessor 35. When autonomous/manual speed control 530 is actuated during autonomous operation of vehicle 10 and/or implement 20, the autonomous navigation software discontinues communicating speed and transmission control commands across the CAN bus 620 of vehicle 10, and an operator may manually control the throttle and/or transmission of vehicle 10. When autonomous/manual speed control 530 is actuated during manual operation, the autonomous navigation software enables autonomous control of the speed and shifting of vehicle 10. While autonomous/manual speed control 530 is shown as a button on armrest 510, autonomous/manual speed control 530 may take the form of a switch, a selectable option on a touchscreen, or any other switch or control.

An autonomous/manual implement control 540 allows an operator to enable or disable autonomous control of implement 20 while allowing autonomous steering and speed control to continue to be performed by autonomous control software running on computer 30 or microprocessor 35. When autonomous/manual implement control 540 is actuated during autonomous operation of vehicle 10 and implement 20, the autonomous navigation software discontinues communicating implement control commands across the CAN bus 620 of vehicle 10 and implement 20, and an operator may manually control functions of implement 20. Implement control functions may include raising or lowering of implement 20, engaging or disengaging row units of implement 20, or any other function related to implement 20. When autonomous/manual implement control 540 is actuated during manual operation, the autonomous navigation software enables autonomous control of implement control functions of implement 20. While autonomous/manual implement control 540 is shown as a button on armrest 510, autonomous/manual implement control 540 may take the form of a switch, a selectable option on a touchscreen, or any other switch or control.

### Man in the Middle CAN

In a tractor or other work vehicle 10, various buttons, levers, dials, and other controls are typically installed on an armrest 510 or similar structure for controlling various aspects of the operation of vehicle 10. For example, speed, shifting, and implement 20 control may be manually controlled using such devices. Instructions from the armrest 510 controls are communicated over a CAN bus 620 to various components of the vehicle 10, such as an engine control unit (ECU) 610, and the components follow the communicated instructions.

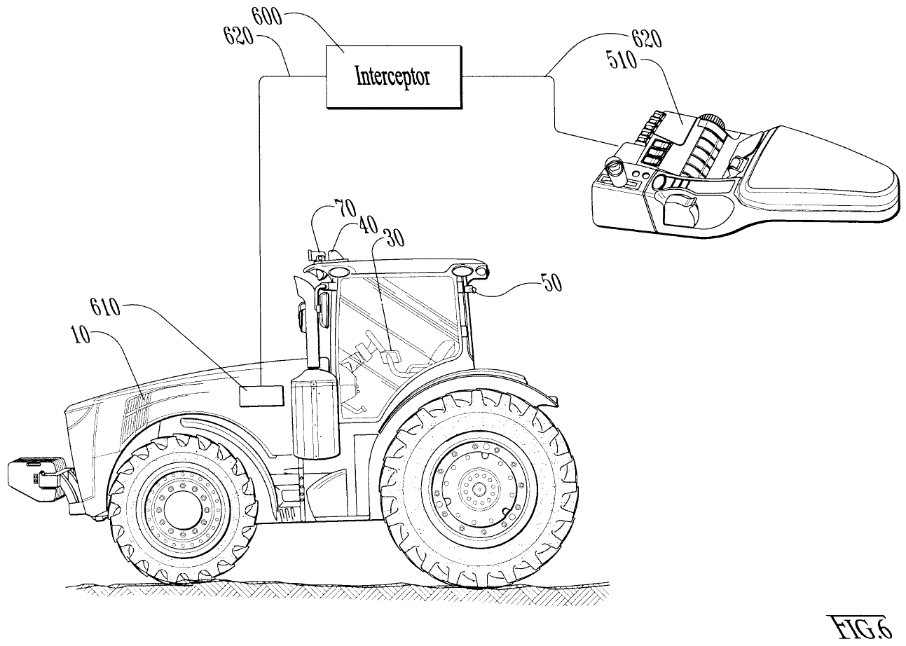

As shown in FIG. 6, an interceptor 600 may be installed between the armrest 510 and the ECU 610 of vehicle 10. When vehicle 10 is operated in manual mode, the operator of the vehicle 10 actuates the controls on armrest 510 to manually control vehicle 10 and implement 20, and instructions from armrest 510 are merely communicated to the ECU 610 via the CAN bus 620 of vehicle 10 without modification. When vehicle 10 is operated in autonomous mode, signals from armrest 510 are intercepted by the interceptor 600, messages implementing autonomous control of vehicle 10 and/or implement 20 are inserted into the intercepted messages using interceptor 600, and the modified messages are communicated to the ECU 610 via the CAN bus 620. Interceptor 600 may comprise a laptop computer, tablet, smart phone, agricultural display, or any similar device capable of intercepting, modifying, and communicating CAN messages.

### Vehicle-to-Vehicle Communications

Autonomous vehicle 10 systems rely on location information provided by a GNSS unit 40 to indicate the precise location of the vehicle 10. Navigation software running on a computer 30 or microprocessor 35 associated with the vehicle 10 uses the real time location of the vehicle 10 along with a mission plan to steer the vehicle 10, control speed of vehicle 10, control implement 20 operation, and perform other functions related to vehicle 10 and implement 20. A real time kinematic (RTK) system in communication with the vehicle 10 via a cellular modem 710 may be used to provide corrections or offsets from a known location to enhance the accuracy of the location data provided by the GNSS unit 40. In some embodiments, an RTK base station 700 provides location corrections to a vehicle 10. At times, a vehicle 10 may lose communications to the RTK service and backend, which could potentially leave a vehicle 10 unable to continue working until connectivity is restored.

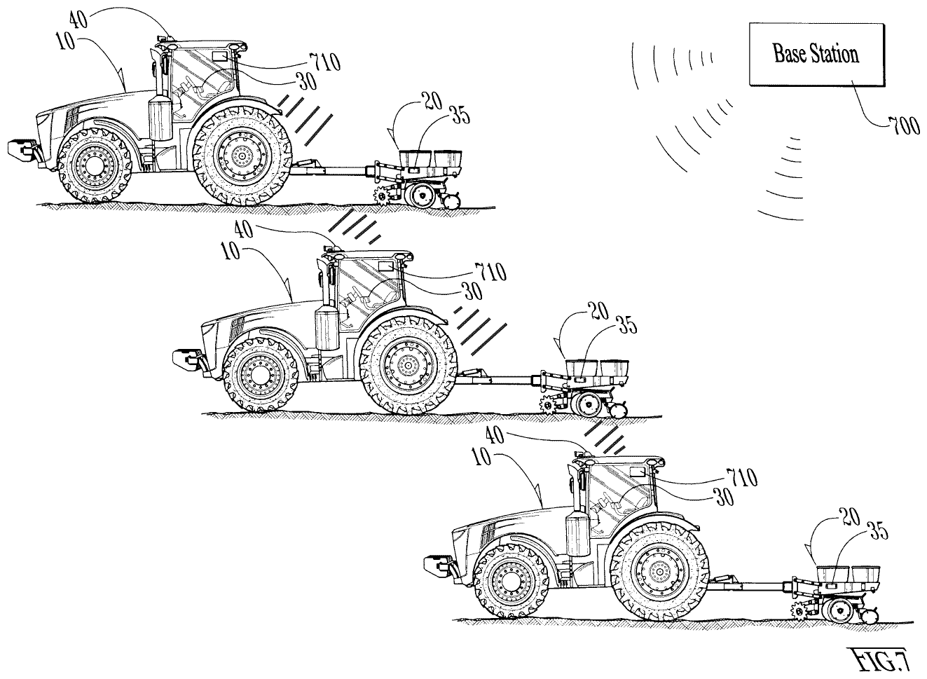

As shown in FIG. 7, a plurality of work vehicles 10 may operate in a work area to perform a work operation. Each vehicle 10 may be towing an implement 20. Throughout the disclosure, the term “swarm” may be used to refer to a group of vehicles 10 performing the same operation or related operations in a work area. Each vehicle 10 is equipped with a GNSS unit 40 to provide the geographic location of the vehicle 10 and a computer 30 or microprocessor 35.

Each vehicle 10 is equipped with a cellular modem 710 configured to transmit and receive signals via a cellular network. Through its cellular modem 710, each vehicle 10 in the swarm may communicate with the RTK base station 700, each of the other vehicles 10 in the swarm, and any other device equipped with a cellular modem 710. If one vehicle 10 loses connectivity to the RTK service and/or backend, the vehicle 10 that has lost service may connect to a local wireless area network to achieve internet access and query any other vehicle 10 in the swarm for RTK information, allowing the vehicle 10 that lost connectivity to continue executing the mission plan. In addition to location information, the local network formed among the vehicles 10 in the swarm may be used for real-time collision avoidance or for dynamic job optimization. The local network may also be used for sharing field level data that may be appropriate. As one example, in one embodiment, if ground force is being controlled autonomously by the navigation software running on each vehicle 10 in a swarm, one vehicle 10 can communicate to the other vehicles 10 in the swarm to reduce or otherwise modify ground force when needed.

### Swarm Safety

When a vehicle 10 is operating autonomously or is being controlled remotely, a field user may approach the vehicle 10 believing that it has been paused, creating a safety issue for the field user. This problem can occur when a swarm of remotely controlled vehicles 10 is operating in a work area as the remote operator can sometimes become confused about which vehicle 10 in the swarm they are controlling and set the wrong vehicle in motion.

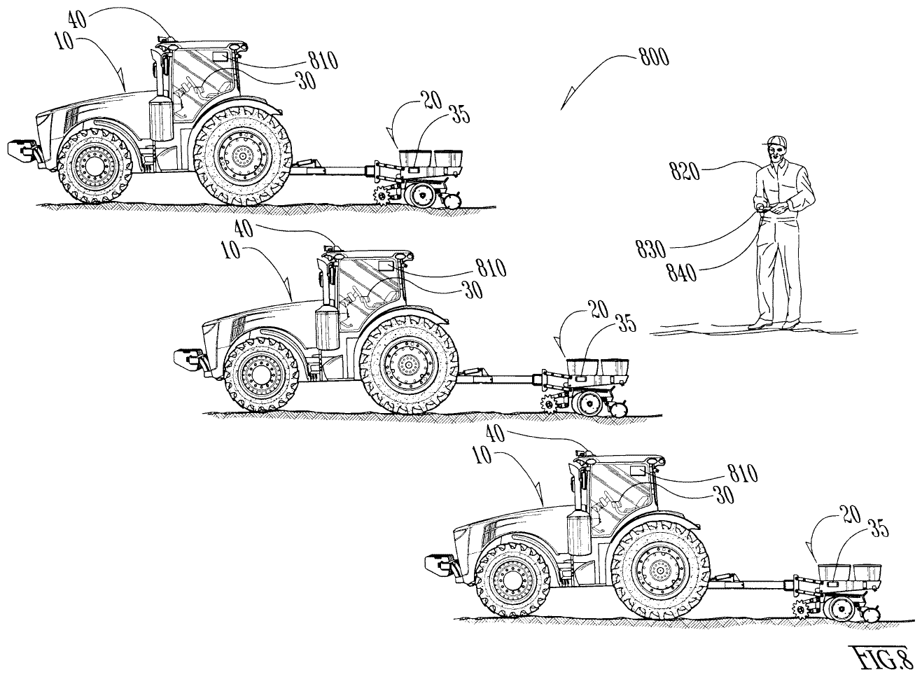

As shown in FIG. 8, a system 800 for improving safety in the vicinity of an autonomous or remotely controlled vehicle 10 includes one or more vehicles 10 where each vehicle 10 is equipped with a vehicle Bluetooth module 810 configured to send signals to and receive signals from other Bluetooth modules 810. A computer 30 or microprocessor 35 associated with each vehicle 10 is configured to communicate with the vehicle Bluetooth module 810. Software running on the computer 30 or microprocessor 35 controls various functions of vehicle 10 and an implement 20 being pulled by vehicle 10.

A field user 820 often carries a cellular telephone 830 or similar device equipped with a device Bluetooth module 840. Device Bluetooth module 840 may be any other Bluetooth module sensed in the vicinity of the vehicle Bluetooth module 810. If the vehicle Bluetooth module 810 of a vehicle 10 detects a device Bluetooth module 840, then software running on computer 30 and/or microprocessor 35 instructs the vehicle 10 and/or implement 20 to shut down in order to protect a field user 820 who may be in the vicinity of the vehicle 10.

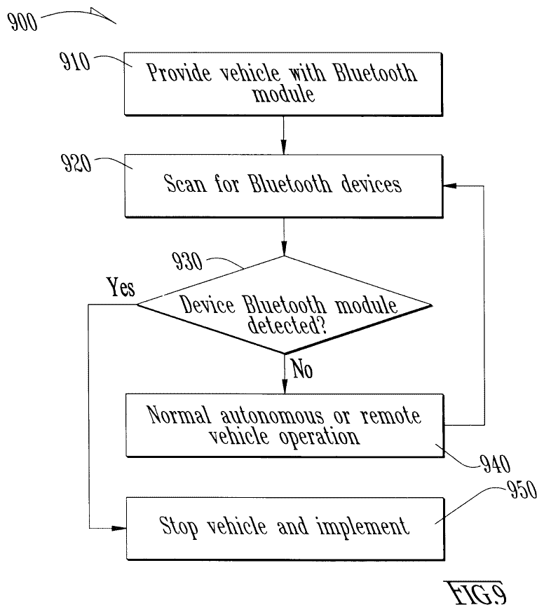

As shown in FIG. 9, a method 900 for improving safety in the vicinity of an autonomous or remotely controlled vehicle 10 begins at step 910 with providing an autonomous or remotely controlled vehicle 10 equipped with a vehicle Bluetooth module 810.

At step 920, the vehicle Bluetooth module 810 scans for another Bluetooth module, called a device Bluetooth module 840.

At step 930, software running on computer 30 or microprocessor 35 determines if a device Bluetooth module 840 was detected. If no device Bluetooth module 840 was detected at step 920, then the method proceeds to step 940, the presence of a field user 820 is not indicated, and normal autonomous or remote operation of the vehicle 10 begins or continues. If a device Bluetooth module 840 was detected at step 920, then a field user 820 is likely present, and the method proceeds to step 950. In some cases, the vehicle Bluetooth module 810 may detect itself or the Bluetooth module 810 of another known vehicle 10 operating in the work area. To avoid interrupting vehicle 10 unnecessarily in such situations, if a recognized vehicle Bluetooth module 810 is detected at step 930, then the recognized vehicle Bluetooth module 810 will be disregarded and treated as if no device Bluetooth module 840 was detected, and the method will proceed to step 940.

At step 950, vehicle 10 and/or implement 20 are stopped from moving through the work area. Vehicle 10 may be completely shut down. Additionally, other operation of vehicle 10 or implement 20 may be stopped. For example, movement of the PTO or operation of a sprayer may be stopped if a field user 820 is indicated. Vehicle 10 and implement 20 may then be operated manually by the field user 820 or another person. Once the device Bluetooth module 840 is no longer detected by the vehicle Bluetooth module 810, method 900 normal autonomous or remote vehicle operation may resume.

### Targeted Destruction of Weeds

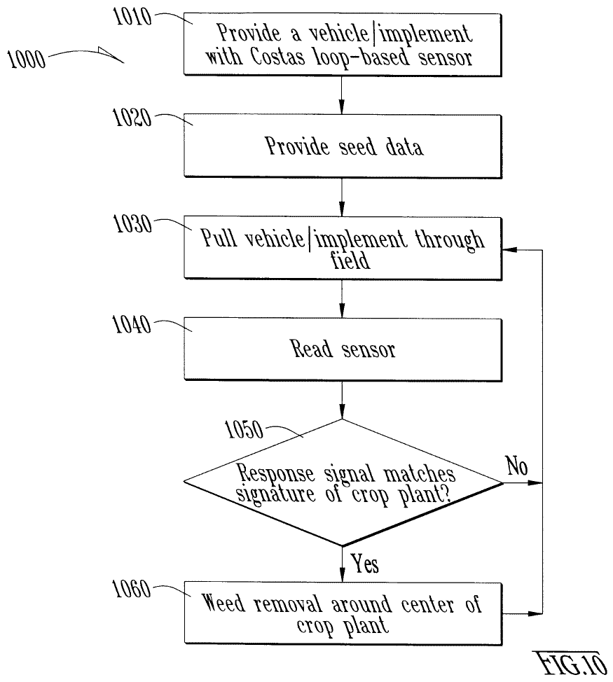

As shown in FIG. 10, a method 1000 for targeted destruction weeds in an agricultural field begins at step 1010 in which a vehicle 10 and/or implement 20 weeds are provided. For the purposes of method 1000, vehicle 10 may be a self-propelled sprayer configured to spray herbicide through a number of nozzles spaced along the sprayer's booms, in which case an implement 20 is not required to complete the method 1000. Alternatively, vehicle 10 may be a tractor pulling an implement 20. Implement 20 may be a sprayer configured to be pulled by a vehicle 10 and spray herbicide through a number of nozzles spaced along the sprayer's booms. Alternatively, implement 20 may be a tillage implement or other implement configured remove or otherwise destroy weeds mechanically, using electricity, using laser, using heat, or using other means. Vehicle 10 and/or implement 20 are equipped with a GNSS unit 40 and a computer 30 and/or microprocessor 35.

One or more sensors 60 installed on vehicle 10 or implement 20 are configured to operate close to a crop row and scan plants encountered while vehicle 10 and/or implement 20 traverse the agricultural field. In one embodiment, sensor 60 implements a Costas loop. Sensor 60 is configured to emit a signal directed at the crop row and receive a signal indicative of the location of individual plants in the crop row. Sensors 60 are in electrical communication with computer 30 and/or microprocessor 35 such that readings from sensors 60 are communicated to computer 30 and/or microprocessor 35.

At step 1020, seed data is provided to computer 30 and/or microprocessor 35. Seed data may include the crop type and seed spacing that was used when the field was planted. Seed data may also include other information such as the seed variety or maps indicating the locations of rows in the field. Seed data may have been stored to computer 30 and/or microprocessor 35 during the planting operation. Alternatively seed data may be transferred to computer 30 and/or microprocessor 35 using a cable connected to another device or using removable storage such as an SD card.

At step 1030, the vehicle 10 and/or implement 20 are driven through an agricultural field in which seeds were previously planted and to which the seed data provided in step 1020 pertains. The path of vehicle 10 is planned such that the wheels of vehicle 10 and the wheels and row units of implement 20 will avoid driving over or striking plants, and the sensors 60 will travel through the rows of plants at a distance such that sensors 60 can determine if a crop plant is present at a location.

At step 1040 a sensor 60 reading is taken. The sensor reading is indicative of whether a crop plant is present at a known location adjacent to the sensor 60. Sensor 60 implements a Costas loop. Taking a sensor 60 reading involves emitting a signal from sensor 60 and receiving a signal in response to the emitted signal.

At step 1050, the response signal is analyzed and compared to signature crop signal for the type of crop planted in the agricultural field. For most agricultural crops, the signature crop signal resembles a square wave. If the signal received by sensor 60 matches the signature of a crop plant, then the method proceeds to step 1060. If the signal received by sensor 60 does not match the signature of a crop plant, method 1000 returns to step 1030.

At step 1060, the center of the crop plant is identified based on the received signal, and weed removal is performed around the identified crop plant. In one embodiment, weed removal may be performed by moving or disturbing the soil a defined radius around the center the crop plant Alternatively, weed removal may be performed by spraying herbicide or by any other known weed destruction method a particular radius around the center of the crop plant Because the approximate crop size and plant spacing are known from the data provided at step 1020, weed removal can be performed without harming the identified plant or adjacent crop plants. After the weed removal operation around the plant is completed, the method 1000 returns to step 1030 in preparation for locating and removing weeds around the next crop plant.

Steps 1030-1060 are repeated as needed to complete the weed removal operation.

### Sensing PTO Rotation

In a mowing operation, an obstruction in the cutting mechanism can cause the clutch to slip on the gear box. When this occurs, a lot of heat is generated, and vegetation adjacent to the gear box can catch fire.

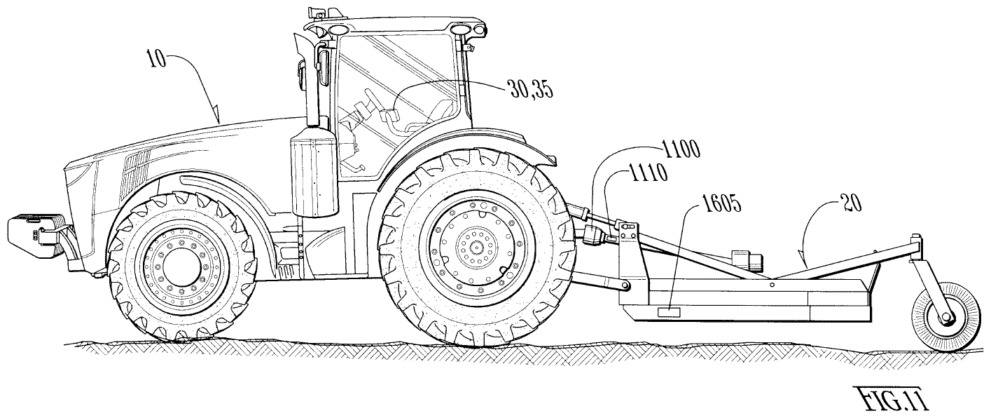

As shown in FIG. 11, a system for determining whether the PTO shaft has stopped rotating comprises a vehicle 10 and an implement 20 being towed by vehicle 10. In one embodiment, vehicle 10 is a tractor and implement 20 is a mower configured to be pulled by vehicle 10. Vehicle 10 and implement 20 may be operating autonomously or may be controlled by a remote operator. PTO shaft 1100 transfers rotational motion from the PTO of vehicle 10 to implement 20, causing the mower blades of implement 20 to turn. A hall effect sensor 1110 is attached on or near the PTO shaft 1100 that connects implement 20 to vehicle 10. The hall effect sensor 1110 is configured to take continuous readings indicative of the state of the PTO shaft 1100. Hall effect sensor 1110 is electronically connected to computer 30 and/or microprocessor 35 such that readings taken by the hall effect sensor 1110 can be communicated to computer 30 or microprocessor 35, and software running on computer 30 or microprocessor 35 can determine if the PTO shaft 1100 is turning. Computer 30 or microprocessor 35 reads the signal sensed by hall effect sensor 1110, calculates the RPM of the PTO shaft 1100, and determines if the RPM of the PTO shaft 1100 is below a threshold. If the RPM is greater than or equal to the threshold, then normal operation can continue. If the RPM is less than the threshold, then a non-rotating PTO shaft 1100 is indicated, the PTO shaft 1100 is turned off, and an error is generated.

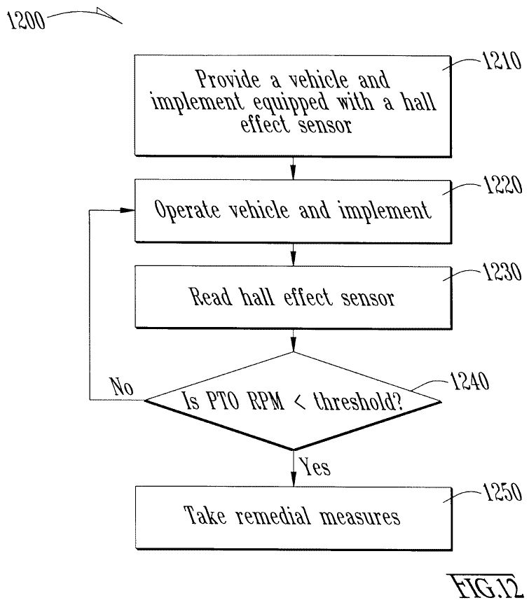

As shown in FIG. 12, a method 1200 for determining whether PTO shaft 1100 has stopped rotating begins at step 1210 with providing an vehicle 10 equipped with a computer 30 and/or a microprocessor 35. Vehicle 10 may be a tractor pulling an implement 20, and implement 20 may be a mower. Vehicle 10 may be a manned or unmanned vehicle; however, method 1200 is particularly beneficial for autonomous or remotely controlled operations as the method 1200 allows a vehicle 10 to determine when the PTO shaft 1100 is not rotating when a human operator is not present.

At step 1220, the vehicle 10 is operated normally. In one embodiment, vehicle 10 and implement 20 are engaged in a mowing operation, and during normal operation the vehicle 10 is typically driven from one end of an area to be mowed to the other end such that grass and other vegetation is mowed as implement 20 passes over it. The vehicle 10 may be steered according to a mission plan loaded in computer 30, and operation of any implement 20 may be controlled by software running on computer 30 or microprocessor 35. For example, control software for implement 20 may control the mower deck height, rotation speed of the mower blades, or any other operation of implement 20.

At step 1230, readings from the hall effect sensor 1110 are taken. While the vehicle 10 is operating, readings from the hall effect sensor 1110 attached adjacent to the PTO shaft 1100 are continually captured and communicated to computer 30 or microprocessor 35.

At step 1240, the RPM of the PTO shaft 1100 is calculated from the readings from the hall effect sensor 1110 taken at step 1230. The RPM is calculated at step 1240 by software running on computer 30 or microprocessor 35. If the RPM is greater than or equal to a defined threshold, then normal rotation of PTO shaft 1100 is indicated, and the method 1200 returns to step 1220. Steps 1220-1240 repeat and normal operation of vehicle 10 and implement 20 continues as long as the mowing operation continues and PTO shaft 1100 RPM remains greater than or equal to the defined threshold.

If at step 1240 the RPM is less than the defined threshold, a non-rotating mower blade may be indicated, and the method 1200 proceeds to step 1250.

At step 1250, remedial measures are taken to avoid overheating. In one embodiment, remedial measures may include shutting down the PTO shaft 1100 and generating an error message that is communicated to computer 30 and/or microprocessor 35. Remedial measures may also include raising implement 20. Method 1200 may resume once vehicle 10 and/or implement 20 have been inspected and any blockages or other needed repairs are handled.

### Prescriptive Mowing

During a typical mowing operation in an area, a self-propelled mower or a tractor pulling a mower travel across the area with the mower blades rotating in order to cut the grass and other vegetation in the area. The length to which the grass and other vegetation are cut is typically set by manually adjusting the height of the mower deck; thus raising or lowering height of the mower blades.

The appropriate length for grass and other vegetation in an area depends on many considerations including the type of grass, time of year, and the amount of precipitation that the area has received recently. Another consideration when determining appropriate mower height is the type of birds that frequent the area. Birds can be problematic in certain areas such as airports where birds can cause damage when they collide with aircraft or enter aircraft engines. When grass and other vegetation in the area is trimmed to a particular length, it can discourage birds from nesting or resting in the area. For example, longer coarse grass is believed to irritate geese and discouraging them from staying in an area.

A system for prescriptive mowing based on time of year and the type of birds that frequent the area comprises a vehicle 10. In one embodiment, vehicle 10 is a tractor towing an implement 20 that comprises a mower as shown in FIG. 11. In another embodiment, vehicle 10 is a self-propelled mower. Vehicle 10 and implement 20 may be operating manually or autonomously or may be controlled by a remote operator. The vehicle 10 may be steered according to a mission plan loaded into control software that is operating on a computer 30 or microprocessor 35. Computer 30 or microprocessor 35 are installed on and configured to control vehicle 10 and/or implement 20, and operation of the implement 20 may also be controlled by the software running on computer 30 or microprocessor 35. For example, control software for implement 20 may control raising and lowering of the implement 20, starting or stopping motion of the mower blades, adjusting the mowing height, adjusting the rotational speed of the mower blades, or any other operation of implement 20.

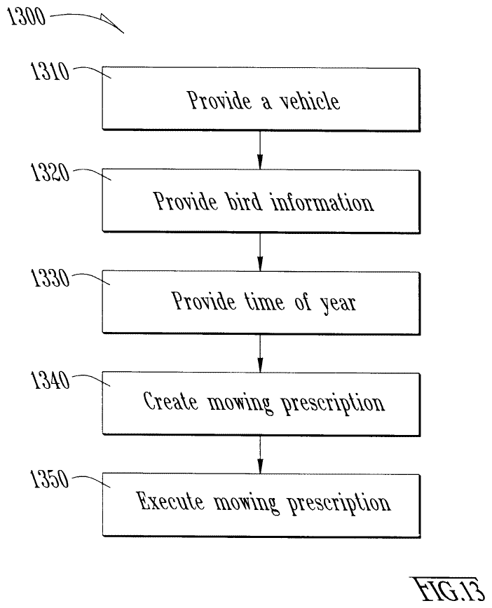

As shown in FIG. 13, a method 1300 for prescriptive mowing of an area based on the time of year and type of birds that frequent the area begins at step 1310 with providing a vehicle 10 equipped with a GNSS unit 40. In one embodiment, vehicle 10 is a tractor pulling an implement 20 wherein implement 20 is a mower. In another embodiment, vehicle 10 is a self-propelled mower. Vehicle 10 may be a manned or unmanned vehicle; however, the method 1300 is particularly beneficial for autonomous or remotely controlled operations as the method 1300 allows for grass and other vegetation to be cut to an appropriate height without a human operator present.

At step 1320, bird information indicative of the types of birds that frequent the area is provided to control software running on computer 30 or microprocessor 35. In one embodiment, bird information may be manually selected or entered when creating a mission plan for the mowing operation. In another embodiment, bird information may be retrieved from a database by the control software based on the geographic location determined from the GNSS unit 40.

At step 1330, the time of year is provided to control software running on computer 30 or microprocessor 35. The time of year may be manually entered, retrieved from the system clock of computer 30 or microprocessor 35, or retrieved from another source. The time of year provided at step 1330 may comprise a specific date or a season.

At step 1340, a mowing prescription is created for the area. The area to be mowed may be divided into one or more zones based on geographical or topological features of the area. The mowing prescription assigns an appropriate mowing height for each zone in the area, and the mowing height is calculated as a function of the bird information provided at step 1320, the time of year provided at step 1330, and features of the zone or area. In one embodiment, the mowing prescription is created on a separate processor such as a personal computer, laptop, tablet, smart phone, or similar device and then loaded onto computer 30 or microprocessor 35 to be executed by control software running on computer 30 or microprocessor 35. Alternatively, the mowing prescription may be generated by software running on computer 30 or microprocessor 35.

At step 1350, control software running on computer 30 or microprocessor 35 executes the mowing prescription generated at step 1340. The vehicle 10 and implement 20 are operated in the area. The location of vehicle 10 and implement 20 is continually determined using the GNSS unit 40. When the control software running on computer 30 or microprocessor 35 determines that the vehicle 10 and implement 20 are entering a zone, the appropriate mowing height for the zone is determined from the mowing prescription created at step 1340, and the control software raises or lowers the mowing deck of implement 20 to achieve the mowing height indicated by the mowing prescription. The control software continues to execute the mowing prescription, raising or lowering the mower deck of implement 20 as indicated by the mowing prescription, until the entire area has been mowed or until the mowing operation is stopped.

### Exiting a Controlled Movement Area

A controlled movement area (CMA) is an area where the presence or movement of people or vehicles 10 is tightly controlled. Specified areas in airports and military bases are examples of CMAs. At times, a CMA must be evacuated, and people and vehicles 10 are directed to leave the CMA. While movement within the CMA is controlled, the land in a CMA still needs to be maintained, such as by mowing grass and other vegetation. In a manned vehicle 10 working in a CMA, the operator of the vehicle 10 can make judgment calls about selecting a safe evacuation location and steering the vehicle 10 quickly toward the evacuation location while avoiding injury or damage to the vehicle 10 or to objects or people in the vehicle's 10 path. When the work in a CMA is performed by autonomous or remotely controlled equipment, no human operator or remote observer is present to make these judgment calls.

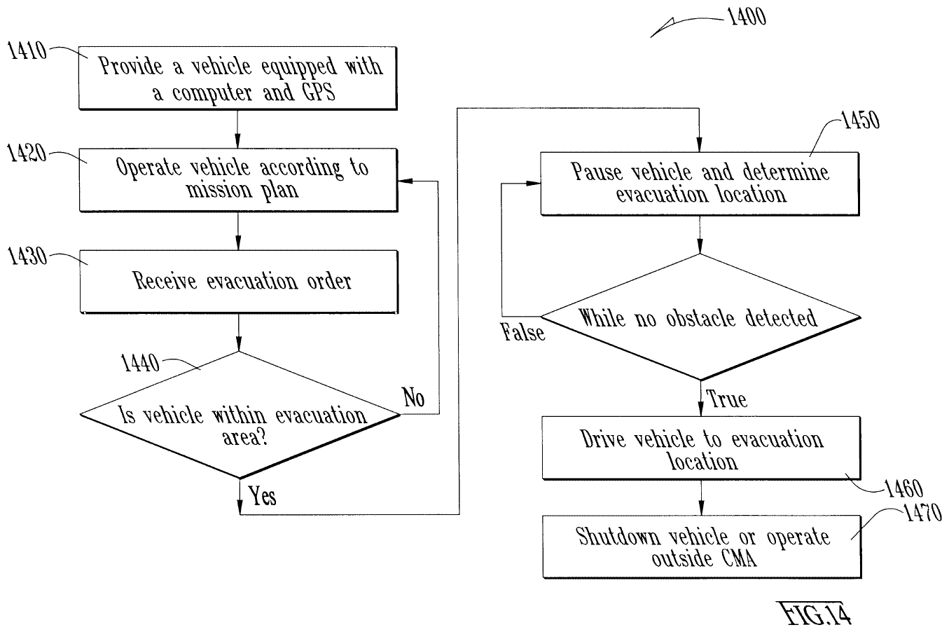

As shown in FIG. 14, a method 1400 of directing an autonomous or remotely controlled vehicle 10 to an evacuation location begins at step 1410 with providing a vehicle 10 equipped with a GNSS unit 40, an obstacle detection system 70 configured to detect people or objects in the path of or near vehicle 10, and a computer 30 and/or a microprocessor 35. Vehicle 10 may be a tractor pulling an implement 20, a mower, a self-propelled sprayer, or other vehicle used for performing operations in an area. Obstacle detection system 70 may comprise any combination of sensors 60 and software running on computer 30 or microprocessor 35 configured to detect people or objects in the path of or near vehicle 10 or implement 20. Vehicle 10 may be a manned or unmanned vehicle; however, the method 1400 is particularly beneficial for autonomous or remotely controlled operations as the method 1400 allows a vehicle 10 to evacuate a CMA without human intervention. Control software running on computer 30 or microprocessor 35 executes a mission plan that controls the steering of vehicle 10, throttle of vehicle 10, and implement 20 control. In one embodiment, the mission plan is created by path planning software running on a remote processor such as a cloud server, in which case commands related to steering, throttle, and implement 20 control are communicated to computer 30 or microprocessor 35 for execution by vehicle 10 and implement 20.

At step 1420, while an evacuation order is not in place the vehicle 10 is operated normally according to a mission plan executed by computer 30 or microprocessor 35. The steering, throttle, and control of implement 20 are adjusted according to the mission plan.

At step 1430, an evacuation order is received by computer 30 or microprocessor 35. In one embodiment the evacuation order may be communicated from an airport control tower, through the U.S. emergency broadcast system, or through a similar communication system.

At step 1440, the control software running on computer 30 or microprocessor 35 reads location information from the GPS unit 40 and the path planning algorithms controlling vehicle 10 and implement 20 determine whether the vehicle 10 is in the CMA. If the vehicle 10 is outside the CMA, then in one embodiment operation of the vehicle 10 is paused outside the CMA for the duration of the evacuation order. In another embodiment, if the vehicle 10 is outside the CMA, then normal operations may continue; however, if continued execution of the mission plan will take vehicle 10 into the CMA then the control software will either stop vehicle 10 outside the CMA or dynamically alter the mission plan to let the work operation continue in areas outside the CMA. If the vehicle 10 and/or implement 20 are inside the CMA, then the method 1400 proceeds to step 1450. In one embodiment, the determination of whether the vehicle 10 is in the CMA at step 1440 is made by the path planning software running on a remote processor. In another embodiment, the determination of whether the vehicle 10 is in the CMA is made by control software running on computer 30 or microprocessor 35 as described in the section entitled “Edge computing of mission plan.”

At step 1450, operation of the vehicle 10 and implement 20 is paused and an evacuation location that is the location that is outside of the CMA but still inside the geofence for vehicle 10 and/or implement 20 with the shortest travel time is determined. The evacuation location may be the location outside the CMA and inside the geofence that is closest to vehicle 10 and/or implement 20, or may be another location if obstacles or ground conditions exist in the path to the location that is geographically the closest. The evacuation point may be a predefined safe distance away from the CMA. In one embodiment the evacuation location must be 250 feet from the border of a CMA; however any predefined distance from the CMA may be used without departing from the scope of the disclosure. In one embodiment, the determination of the evacuation location at step 1450 is made by the path planning software running on a remote processor. In another embodiment, the determination of the evacuation location is made by control software running on computer 30 or microprocessor 35 as described in the section entitled “Edge computing of mission plan.”

At step 1460, the control software drives vehicle 10 and/or implement 20 to the evacuation point selected at step 1450. While driving to the evacuation point, the obstacle detection system 70 determines whether there are any people or other obstacles in the path of or near vehicle 10 or implement 20. If the obstacle detection system 70 detects that there are no people or other obstacles, then the vehicle 10 and implement 20 continue to the selected evacuation point as planned. If the obstacle detection system 70 detects a person or other obstacle in the path of or near vehicle 10 or implement 20, then the method 1400 returns to step 1450, in which operation of vehicle 10 and implement 20 is ceased and a new evacuation location is determined.

Steps 1450 and 1460 repeat as needed until the vehicle 10 and implement 20 have reached the evacuation location. At step 1470, the vehicle 10 and implement 20 stop at the evacuation location. The vehicle 10 and implement 20 may then be shutdown, or if the mission plan includes work in areas outside the CMA then work may continue in areas outside the CMA

Work in the CMA may resume once the evacuation order is cancelled.

### Edge Computing of Mission Plan

As described previously in the section entitled “Exiting a controlled movement area,” at times, a CMA must be evacuated, and people and vehicles 10 are directed to leave the CMA. When an evacuation order is issued, people and vehicles 10 must exit the CMA as quickly as possible. When path planning algorithms directing work in the area by a vehicle 10 run on remote path planning software, delays could occur in communicating between control software running on computer 30 and/or microprocessor 35.

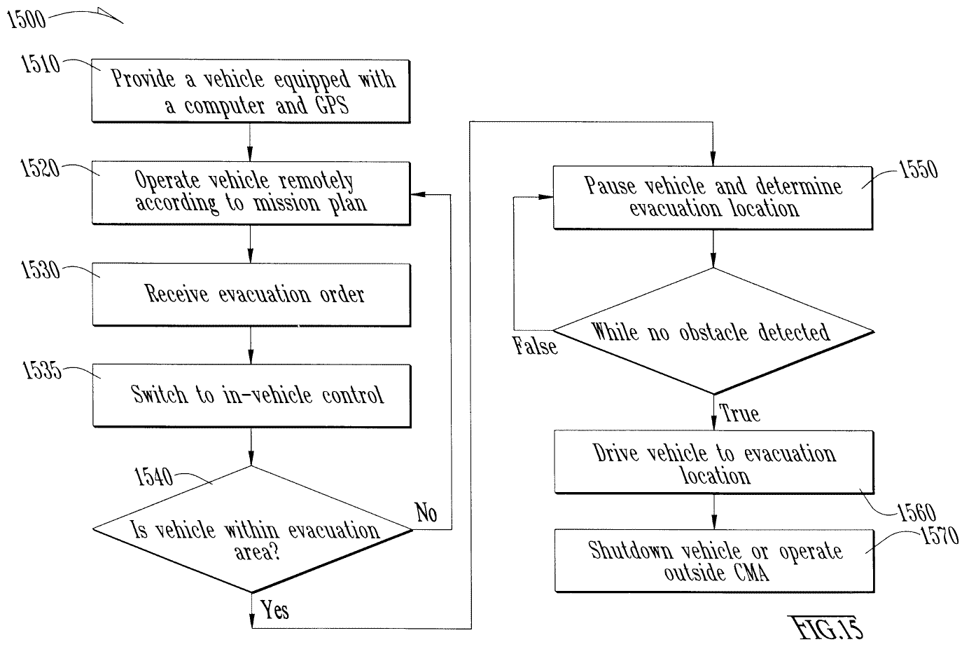

As shown in FIG. 15, a method 1500 of switching vehicle 10 and implement 20 control from cloud-based control algorithms to in-vehicle 10 control algorithms in the event of an evacuation begins at step 1510 with providing a vehicle 10 equipped with a GPS unit 40, an obstacle detection system 70 configured to detect people or objects in the path of or near vehicle 10, and a computer 30 and/or a microprocessor 35. Vehicle 10 may be a tractor pulling an implement 20, a mower, a self-propelled sprayer, or other vehicle used for performing operations in an area. Obstacle detection system 70 may comprise any combination of sensors 60 and software running on computer 30 or microprocessor 35 configured to detect people or objects in the path of or near vehicle 10 or implement 20. Vehicle 10 may be a manned or unmanned vehicle; however, the method 1400 is particularly beneficial for autonomous or remotely controlled operations as the method 1400 allows a vehicle 10 to evacuate a CMA without human intervention. Control software running on computer 30 or microprocessor 35 executes a mission plan that controls the steering of vehicle 10, throttle of vehicle 10, and implement 20 control. The mission plan is created by path planning software running on a remote processor such as a cloud server, in which case commands related to vehicle 10 steering, vehicle 10 throttle control, and implement 20 control are communicated to computer 30 or microprocessor 35 for execution by vehicle 10 and implement 20.

At step 1520, while an evacuation order is not in place the vehicle 10 is operated normally according to a mission plan executed by computer 30 or microprocessor 35. The steering, throttle, and control of implement 20 are adjusted according to the mission plan as directed by path planning software running on the remote processor.

At step 1530, an evacuation order is received at computer 30 or microprocessor 35. In one embodiment the evacuation order may be communicated from an airport control tower, through the U.S. emergency broadcast system, or through a similar communication system.

At step 1535, commands related to vehicle 10 steering, vehicle 10 throttle control, and implement 20 control communicated from the remote processor are disregarded, and control software running on computer 30 and/or microprocessor 35 assume control of vehicle 10 steering, vehicle 10 throttle control, and implement 20 control.

At step 1540, the control software running on computer 30 or microprocessor 35 reads location information from the GPS unit 40 and determines whether the vehicle 10 is in the CMA. If the vehicle 10 is outside the CMA, then in one embodiment operation of the vehicle 10 is paused outside the CMA for the duration of the evacuation order. In another embodiment, if the vehicle 10 is outside the CMA, then normal operations may continue; however, if continued execution of the mission plan will take vehicle 10 into the CMA then the control software will either stop vehicle 10 outside the CMA or dynamically alter the mission plan to let the work operation continue in areas outside the CMA. If the vehicle 10 and/or implement 20 are inside the CMA, then the method 1500 proceeds to step 1550.

At step 1550, operation of the vehicle 10 and implement 20 is paused by control software running on computer 30 or microprocessor 35, and an evacuation location that is the location that is outside of the CMA but still inside the geofence for vehicle 10 and/or implement 20 with the shortest travel time is determined by the control software running on computer 30 or microprocessor 35. The evacuation location may be the location outside the CMA and inside the geofence that is closest to vehicle 10 and/or implement 20 or may be another location if obstacles or ground conditions exist in the path to the location that is geographically the closest. The evacuation point may be a predefined safe distance away from the CMA. In one embodiment the evacuation location must be 250 yards from the border of a CMA; however any predefined distance from the CMA may be used without departing from the scope of the disclosure.

At step 1560, the control software running on computer 30 or microprocessor 35 drives vehicle 10 and/or implement 20 to the evacuation point selected at step 1550. While driving to the evacuation point, the obstacle detection system 70 determines whether there are any people or other obstacles in the path of or near vehicle 10 or implement 20. If the obstacle detection system 70 detects that there are no people or other obstacles, then the vehicle 10 and implement 20 continue to the selected evacuation point as planned. If the obstacle detection system 70 detects a person or other obstacle in the path of or near vehicle 10 or implement 20, then the method 1500 returns to step 1550, in which operation of vehicle 10 and implement 20 is ceased and a new evacuation location is determined.

Steps 1550 and 1560 repeat as needed until the vehicle 10 and implement 20 have reached the evacuation location. At step 1570, the vehicle 10 and implement 20 stop at the evacuation location. The vehicle 10 and implement 20 may then be shutdown, or if the mission plan includes work in areas outside the CMA then work may continue in areas outside the CMA

Once the vehicle 10 is outside the CMA, the remote path planning software may resume control of vehicle 10 steering, vehicle 10 throttle control, and implement 20 control. Work in the CMA may resume once the evacuation order is cancelled.

### Detecting Buried Obstacles

Some work areas contain buried equipment such as pipes or cables, portions of which can extend above the ground's surface. If struck by a mower blade or other working part of a vehicle 10 or implement 20, damage can occur to the equipment, vehicle 10, or implement 20. Typically, such buried equipment would be treated as an obstacle, and the vehicle 10 would avoid driving over the buried equipment.

As shown in FIG. 11, a system for detecting buried obstacles in the vicinity of a working vehicle 10 comprises a vehicle 10 and in some embodiments an implement 20 being towed by vehicle 10. In one embodiment, vehicle 10 is a self-propelled mower. In another embodiment, vehicle 10 is a tractor and implement 20 is a mower configured to be pulled by vehicle 10. Vehicle 10 and implement 20 may be operating autonomously or may be controlled by a remote operator. PTO shaft 1100 transfers rotational motion from the PTO of vehicle 10 to implement 20, causing the mower blades of implement 20 to turn. A radar unit 1605 is attached to vehicle 10 or implement 20. The radar unit 1605 is configured to emit radar signals and receive reflected radar signals. Radar unit 1605 is electronically connected to computer 30 and/or microprocessor 35 such that readings taken by the radar unit 1605 can be communicated to computer 30 or microprocessor 35, and software running on computer 30 or microprocessor 35 can determine if the reflected signals represent the terrain expected in the work area or an obstacle such as a buried cable or pipe. If the reflected signal is indicative of an obstacle, then the implement 20 may be raised. For example, in a mowing operation, when a buried obstacle such as a pipe or cable is detected, then the mower deck may be raised before the implement 20 reaches the buried obstacle.

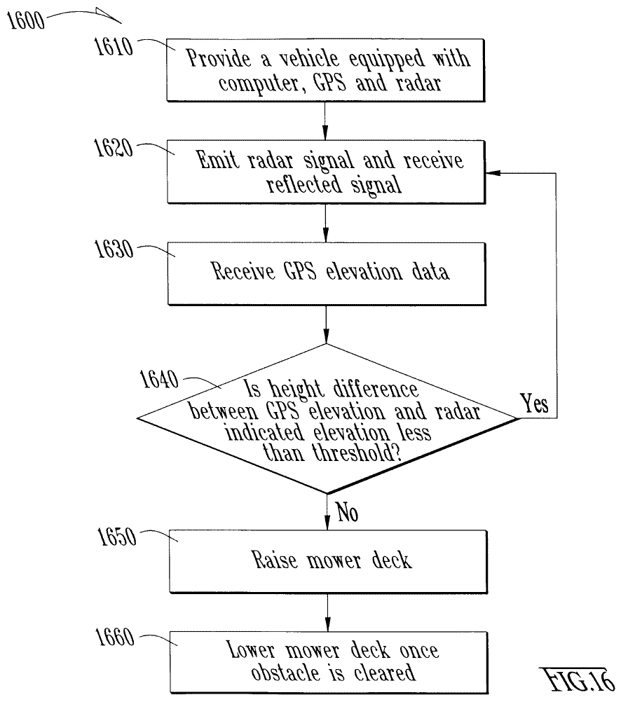

As shown in FIG. 16, a method 1600 for detecting a buried obstacle in the vicinity of a working vehicle 10 begins at step 1610 with providing a vehicle 10 equipped with a computer 30 and/or a microprocessor 35, a GPS unit 40, and a radar unit 1605. The speed and path of vehicle 10 may be controlled according to a mission plan loaded in computer 30, and operation of any implement 20 may be controlled by software running on computer 30 or microprocessor 35.

At step 1620, radar unit 1605 emits a signal ahead of vehicle 10 and receives the signal's reflection. Signals as transmitted and received continuously as the vehicle 10 traverses the work area.

At step 1630, elevation data is received by GPS unit 40 and transmitted to computer 30 or microprocessor 35. Elevation data is received by GPS unit 40 continuously as the vehicle 10 traverses the work area.

At step 1640, software running on computer 30 or microprocessor 35 compares the elevation data received at step 1630 to the signal received by the radar unit 1605 at step 1620. If the difference between the elevation received at step 1640 and the ground height indicated by the signal received by the radar unit 1605 is less than a defined threshold, then no obstacle is indicated in the area ahead of vehicle 10, and normal operation of the vehicle 10 and/or implement 20 continues. If the difference between the elevation received at step 1640 and the ground height indicated by the signal received by the radar unit 1605 is equal to or greater than a defined threshold, then an obstacle is indicated in the area ahead of vehicle 10, and the method 1600 proceeds to step 1650.

At step 1650, the mower deck of vehicle 10 or implement 20 is raised in advance of the detected obstacle to avoid damage.

At step 1660, the mower deck of vehicle 10 or implement 20 is lowered once clear of the detected obstacle.

Steps 1620-1660 are repeated continuously as needed while the vehicle 10 and/or implement 20 are operating.

### Mowing Contours

When operating on hilly terrain, a work vehicle 10 such as a tractor or any implement 20 being towed by the vehicle may experience wheel slippage where the wheels of the vehicle 10 and/or the implement 20 lose traction and spin, causing damage to the grass and other vegetation in the work area. Slippage is a particular problem when operating in straight lines on hilly terrain.

A system for mowing or performing another work operation on an area of land comprises a vehicle 10. In one embodiment, vehicle 10 is a tractor towing an implement 20 that may comprise a mower as shown in FIG. 11. In another embodiment, vehicle 10 is a self-propelled mower. Vehicle 10 and implement 20 may be operating manually or autonomously or may be controlled by a remote operator. The vehicle 10 may be steered according to a mission plan loaded into control software operating on computer 30 or microprocessor 35. Computer 30 or microprocessor 35 are installed on and configured to control vehicle 10 and/or implement 20, and operation of the implement 20 may also be controlled by the software running on computer 30 or microprocessor 35. For example, control software for implement 20 may control raising and lowering of the implement 20, starting or stopping motion of the mower blades, adjusting the mowing height, adjusting the rotational speed of the mower blades, or any other operation of implement 20.

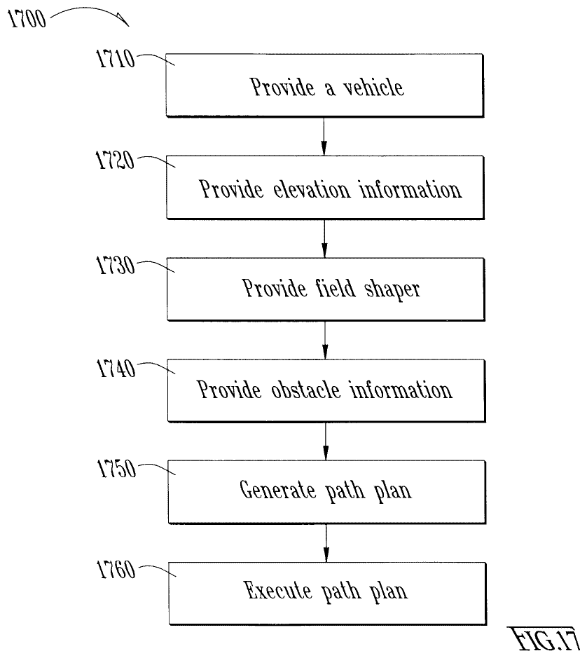

As shown in FIG. 17, a method 1700 for generating a contoured path plan for performing a work operation in an area begins at step 1710 with providing a vehicle 10 equipped with a GPS unit 40. In one embodiment, vehicle 10 is a tractor pulling an implement 20 wherein implement 20 is a mower. In another embodiment, vehicle 10 is a self-propelled mower. Vehicle 10 may be a manned or unmanned vehicle 10; however, the method 1700 is particularly beneficial for autonomous or remotely controlled operations as the method 1700 allows for generating a contoured path plan without the presence of a human operator. In one embodiment, the steps of method 1700 are performed mission planning software running on a computer 30 operating on vehicle 10 or a microprocessor 35 running on implement 20; however, generating a contoured path plan according to method 1700 may be performed by mission planning software running on a remote computer and communicated or downloaded to computer 30 or microprocessor. Further, the contoured path plan generated using method 1700 may be created prior to the mowing operation begins, or may be generated as the operation is taking place.

At step 1720, elevation information for the area to be mowed is provided to the mission planning software. In one embodiment, elevation information may be retrieved from a database by the control software prior to beginning the mowing operation. In another embodiment, elevation information may be obtained from the GPS unit 40.

At step 1730, field shape information is provided to the mission planning software. The field shape may be obtained by manually driving around the perimeter of the area to be mowed. Alternatively, the field shape may be retrieved by a database or manually entered.

At step 1740, obstacle information is provided to control software running on computer 30 or microprocessor 35. Obstacles may include ditches or any other object or feature in the work area that should be avoided by vehicle 10 and implement 20.

At step 1750, a path plan is created for the area. The area to be mowed may be divided into one or more zones based on elevation, field shape, and obstacles or features of the area. The path plan maps out one or more A-B lines covering the area based on the elevation information provided at step 1720, field shape provided at step 1730, and obstacles or features of the zone or area provided at step 1740. If the change in elevation of a zone or area is below a threshold, relatively flat land is indicated, and the A-B lines generated for the area or zone may be generally straight lines covering the area to be worked. If the change in elevation of a zone or area is above the threshold, hilly terrain is indicated, and A-B lines generated for the area or zone become curved lines that may zig-zag up the hill to avoid wheel slippage that could occur if driving straight up the hill. The curviness of the contours generated at step 1750 may increase as the steepness of the terrain increases, and contours are planned such that vehicle 10 and implement 20 avoid obstacles and remain within the area to be worked. In one embodiment, the path plan is created on a separate processor such as a personal computer, laptop, tablet, smart phone, or similar device and then loaded onto computer 30 or microprocessor 35 to be executed by control software running on computer 30 or microprocessor 35. Alternatively, the path plan may be generated by software running on computer 30 or microprocessor 35.

At step 1760, control software running on computer 30 or microprocessor 35 executes the mission plan following the contoured A-B lines generated at step 1750. The vehicle 10 and implement 20 are operated in the area. The location of vehicle 10 and implement 20 is continually determined using the GPS unit 40, and the control software steers the vehicle 10 to follow the A-B lines generated at step 1750.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for controlling an autonomous vehicle operating around a controlled movement area comprising:
operating the autonomous vehicle according to a mission plan executed by a processor communicating with the vehicle;
receiving an evacuation order at the processor;
pausing execution of the mission plan;
determining a current location of the vehicle from a GNSS unit installed on the vehicle;
determining an evacuation location if the current location of the vehicle is within the controlled movement area; and
driving the vehicle to the evacuation location.

2. The method of claim 1 wherein the evacuation location comprises a location outside the controlled movement area and a defined distance away from the boundary of the controlled movement area.

3. The method of claim 1 wherein the step of driving the vehicle to the evacuation location further comprises pausing the vehicle, determining a new evacuation location, and driving the vehicle to the new evacuation location if an obstacle is detected.

4. The method of claim 1 further comprising operating the autonomous vehicle according to the mission plan in areas outside the controlled movement area.

5. The method of claim 1 further comprising receiving a cancellation of the evacuation order and resuming the mission plan.
